(19) United States
(12) Patent Application Publication
(10) Pub. No.: US 2024/0257064 A1
(43) Pub. Date: Aug. 1, 2024

(54) MESSAGING SYSTEM WITH EXTERNAL CONTACTS, EVENTS, AND CLOUD STORAGE INTEGRATION

(71) Applicant: Workstorm.com LLC, Chicago, IL (US)

(72) Inventors: Raj FERNANDO, Chicago, IL (US); Anatoliy YUDOVICH, Chicago, IL (US); Michael BARRY, Chicago, IL (US); Andrew CHRISTENSEN, Chicago, IL (US)

(21) Appl. No.: 18/101,667

(22) Filed: Jan. 26, 2023

(51) Int. Cl. G06Q 10/1093; G06F 3/0482; H04L 12/18; H04L 51/046; H04L 51/063

(52) U.S. Cl. CPC G06Q 10/1095; G06F 3/0482; H04L 12/1818; H04L 51/046; H04L 51/063

(57) ABSTRACT

Disclosed herein are system, method, and computer program product embodiments for integrating external contacts, events, and cloud storage systems with a messaging system. The messaging system may interface with one or more events systems and/or cloud storage systems while facilitating the delivery of messages. These may include chat and/or instant messages. Via application programming interface (API) calls to the events systems, the messaging system may retrieve contact information for generating calendar events. The messaging system may instruct the events system to generate an event and/or send invitations to the event. The messaging system may also instruct the events systems to invite contacts to a video conference. Via API calls to the cloud storage systems, the messaging system may access files stored by the cloud storage systems. The messaging system may share the files between users using chat panels and/or update file permissions on the cloud storage systems.

### BACKGROUND

### Field

This field is generally related to integrating external contacts, events, and cloud storage with a messaging system.

### Related Art

As the demands of the workplace evolve, organizations often find themselves using multiple services to facilitate different aspects of communication, scheduling, and file management. For example, an organization may use one provider for email messages, another provider for internal chat or instant messaging, and yet another provider for file storage and management. Another issue may include managing calendars and/or calendar appointments. Further complicating this issue, individual users may also have different user accounts for each of these service providers, which may require separate log-ins. Requiring users to individually interface with each of these service provides may be cumbersome and inefficient for workplace productivity.

### BRIEF SUMMARY

Disclosed herein are system, apparatus, device, method and/or computer program product embodiments, and/or combinations and sub-combinations thereof, for integrating external contacts, events, and cloud storage systems with a messaging system.

In some embodiments, a messaging system may interface with one or more events systems and/or cloud storage systems while facilitating the delivery of messages. The messaging system may be implemented using Internet-based components, such as web servers and databases. The messaging system may generate workspaces, which may include one or more graphical user interfaces facilitating message exchanges. The workspaces may include chat panels, file management services, calendar services, meeting and/or video conferencing services, contact management, and/or other communication services. In some embodiments, to facilitate chat message communications, the messaging system may instantiate chat panels as well as provide an interface with user client devices, such as computers, laptops, or tablets for messaging.

To address the issue of an organization using multiple service providers for different aspects of communications, the messaging system may connect and/or integrate these other features. For example, an organization may use the messaging system for chat and/or instant messaging between members or employees of the organization. The organization, however, may use a different service provider for email and calendar functionality and yet another service provider for storage and management of documents. The messaging system described herein may interface with these other service providers to integrate those services within the messaging system. In this manner, members or employees of the organizations may use the messaging system and/or its corresponding graphical user interfaces (GUIs) to interface with these other service providers. For example, the messaging system may provide a portal for using these other service providers.

As further described below, a messaging system may interface with one or more events systems and/or cloud storage systems. Events systems may correspond to service providers providing event management, calendar management, email messaging, and/or contacts messaging services. Cloud storage systems may correspond to service providers providing file management, document management, and/or other data storage functionality. While the events systems and cloud storage systems are sometimes addressed separately, a particular service provider may be able to perform multiple overlapping functionalities. For example, an events system may be able to also manage file data and/or a cloud storage system may also provide email and/or calendar functionality. In this manner, the terms events system and/or cloud storage system are not intended to limit the functionality of those system and/or the functionality that may be integrated with the messaging system.

In some embodiments, the messaging system may integrate contacts records, calendar functionality, event creation, and/or event invitation functionality with an events system. For example, the messaging system may provide a workspace for a user of the messaging system to log into the events system and to retrieve calendar information, which may include calendar events and/or calendar appointments. This calendar information may be used to populate calendar information in the messaging system.

Similarly, the messaging system may retrieve contacts information stored by the events system. This may be from a contact list and/or contacts database. With this information, the messaging system may facilitate the creation of calendar events within the messaging system. For example, a user may create an event and/or identify contacts to invite to the event from the contacts retrieved from the events system. When the user provides a command to create the event with the selected contacts, the messaging system may create the event and/or command the events system to send invitations. For example, the messaging system may add the defined event to a calendar managed by the messaging system, add the defined event to a calendar managed by the events system, send an invitation to the event to the selected contacts, and/or instruct the events system to send an invitation. This may occur via an email messaging service provided by the events system. The contacts invited to the event may have been retrieved from events system and/or from the messaging system. In this manner, the messaging system may provide a portal to the contacts and event invitation functionality provided by the events system.

The messaging system may also interface with a cloud storage system to access files and/or data stored by the cloud storage system. The cloud storage system may be the same or different from the events systems. A user may have a user account specific to the cloud storage system. The messaging system may integrate the file management, document management, and/or other data storage functionality provided by the cloud storage system. For example, the messaging system may provide a portal to the stored files and/or data managed by the cloud storage system.

Via the messaging system's interface with the cloud storage system, a user of the messaging system may view and/or manipulate the files managed by the cloud storage system. The user may also identify files for sharing and share those files using the messaging system. For example, a user may identify a particular folder and/or file and identify another user and/or group of users of the messaging system to receive access to the folder and/or file. The messaging system may then deliver a link to the specified user or group of users to view and/or access the shared document. This may be via a chat panel provided by the messaging system. When accessing the link, the messaging system may provide access to the file as stored on by the cloud storage system. In this manner, the messaging system may be a portal to the cloud storage system for sharing files and/or data.

While the user sharing the file may identify the file from a view of the files on the cloud storage system, the user may also share the file from within a chat panel. For example, the user may interact with a GUI object in the chat panel to open a cloud storage system interface and view the files stored in the cloud storage system. The user may then select the desired file. In response to this selection, the messaging system may transmit a link to the selected file to the recipients corresponding to the chat panel. In this manner, the user may share files stored on the cloud storage system with other users of the messaging system.

In some embodiments, the messaging system may also facilitate searching multiple cloud storage systems. For example, the messaging system may include a search bar in a workspace that may allow a user to search for files across multiple cloud storage systems linked to the user's messaging system account. Similarly, when searching for contacts across multiple events systems, the messaging system may also include a search bar that facilitates this type of search.

The messaging system may provide efficient communications and integration with multiple service providers systems. In this manner, users and organizations may use the messaging system as a hub for messaging as well as for contact retrieval, event generation, and/or file management.

### BRIEF DESCRIPTION OF THE DRAWINGS

The accompanying drawings are incorporated herein and form a part of the specification.

FIG. 1 depicts a block diagram of a messaging environment, according to some embodiments.

FIG. 2A depicts a block diagram of a graphical user interface (GUI) displaying calendar integration, according to some embodiments.

FIG. 2B depicts a block diagram of a graphical user interface (GUI) displaying integration with an events system, according to some embodiments.

FIG. 2C depicts a block diagram of a graphical user interface (GUI) displaying a new event creation page, according to some embodiments.

FIG. 2D depicts a block diagram of a graphical user interface (GUI) displaying video conference invitation page, according to some embodiments.

FIG. 3A depicts a flowchart illustrating a method for retrieving contact records, according to some embodiments.

FIG. 3B depicts a flowchart illustrating a method for sending an event invitation, according to some embodiments.

FIG. 3C depicts a flowchart illustrating a method for sending a video conference invitation, according to some embodiments.

FIG. 4A depicts a block diagram of a graphical user interface (GUI) displaying files from cloud storage systems, according to some embodiments.

FIG. 4B depicts a block diagram of a graphical user interface (GUI) displaying a chat panel with a shared file, according to some embodiments.

FIG. 4C depicts a block diagram of a graphical user interface (GUI) displaying an upload GUI object, according to some embodiments.

FIG. 4D depicts a block diagram of a graphical user interface (GUI) displaying files for uploading, according to some embodiments.

FIG. 5A depicts a flowchart illustrating a method for posting a link to a chat panel, according to some embodiments.

FIG. 5B depicts a flowchart illustrating a method for posting a link to a chat panel from within the chat panel, according to some embodiments.

FIG. 6 depicts a flowchart illustrating a method for searching one or more cloud storage systems for a file, according to some embodiments.

FIG. 7 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for integrating external contacts, events, and cloud storage systems with a messaging system. As further described below, a messaging system may interface with one or more events systems and/or cloud storage systems. This may allow users to use the messaging system as a portal to access and/or generate contacts and/or events managed by an events system. This may also allow users to manage files stored by the cloud storage systems. The messaging system may provide such interactions such that users communicating via chat panels in workspaces provided by the messaging system may communicate with external contacts, invite such contacts to events, and/or generate events from within the messaging system. The messaging system may also allow its users to share files using the chat panels to individuals and/or groups even if such files are managed externally by a cloud storage system.

Various embodiments of these features will now be discussed with respect to the corresponding figures.

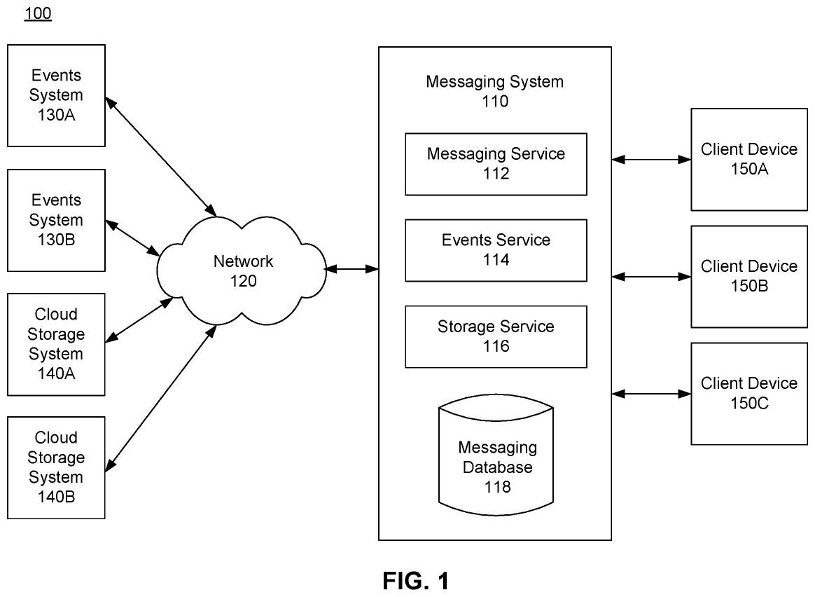

FIG. 1 depicts a block diagram of a messaging environment 100, according to some embodiments. Messaging environment 100 includes messaging system 110, network 120, events systems 130A, 130B, cloud storage systems 140A, 140B, and/or client device 150A, 150B, 150C. Messaging system 110 may include messaging service 112, events service 114, storage service 116, and/or messaging database 118.

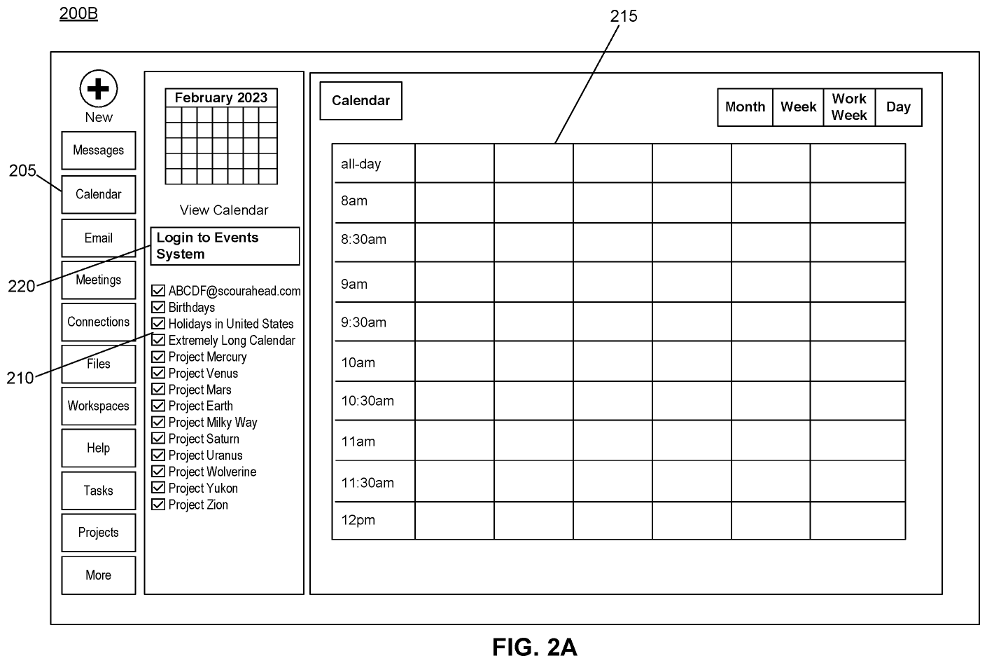

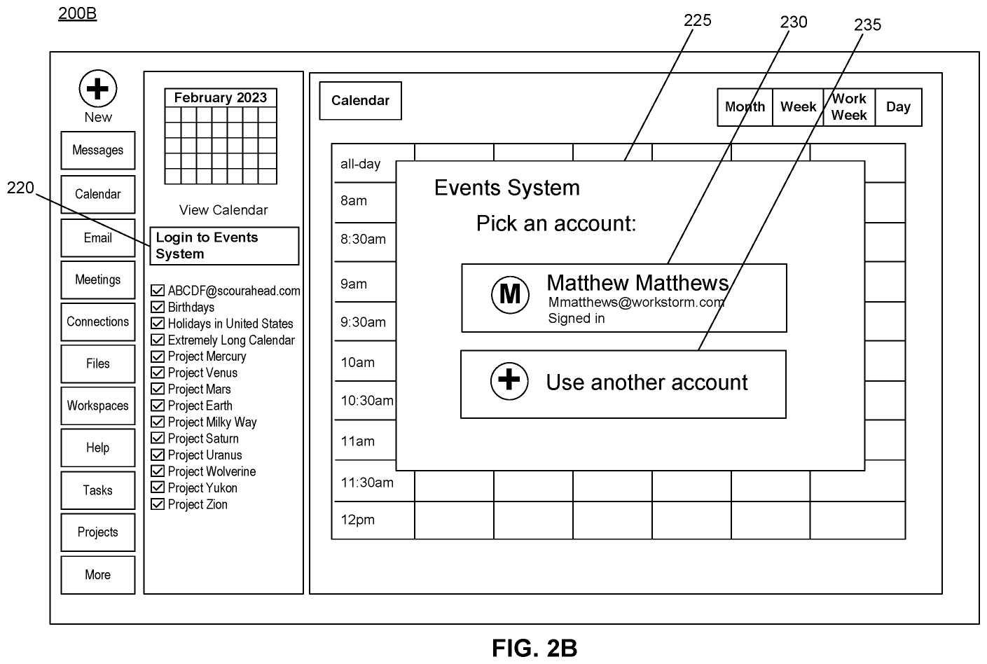

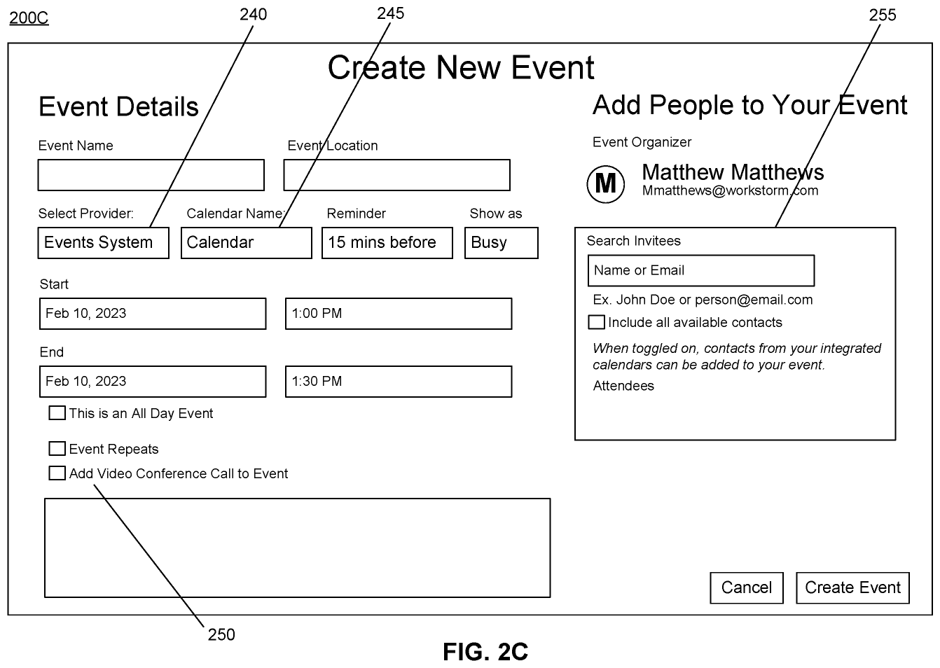

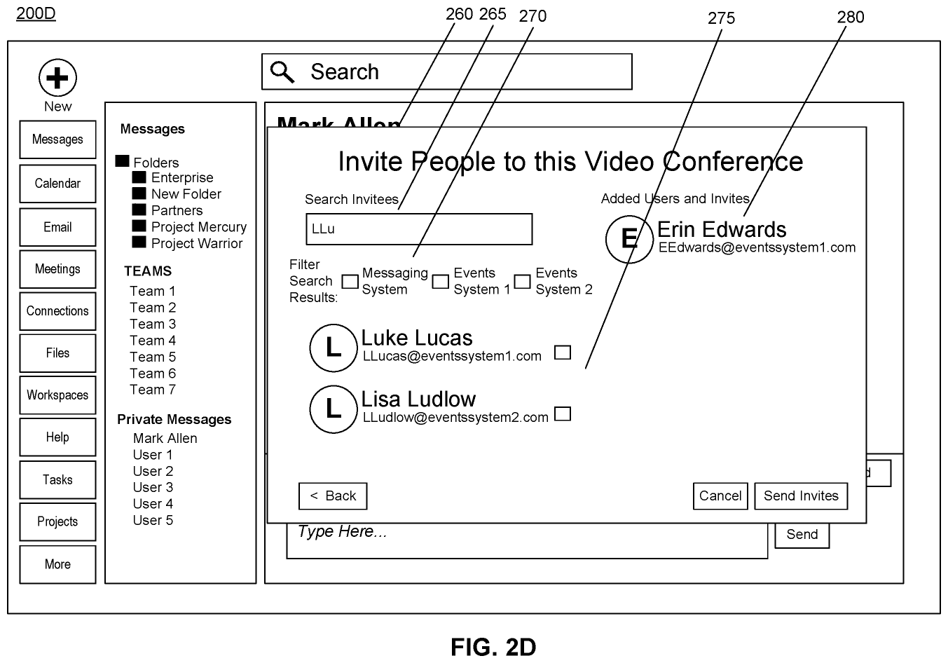

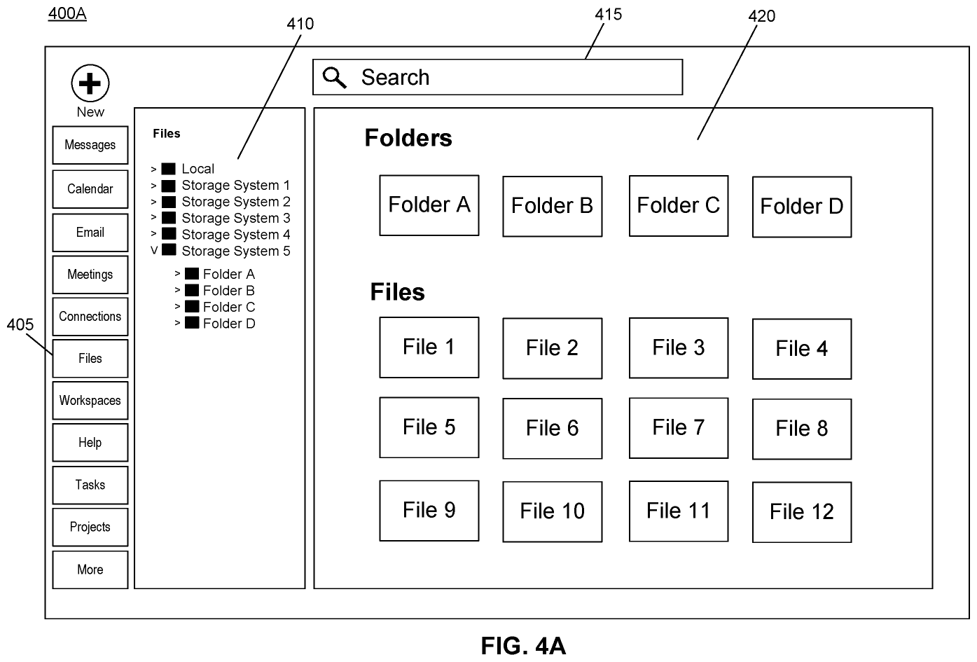

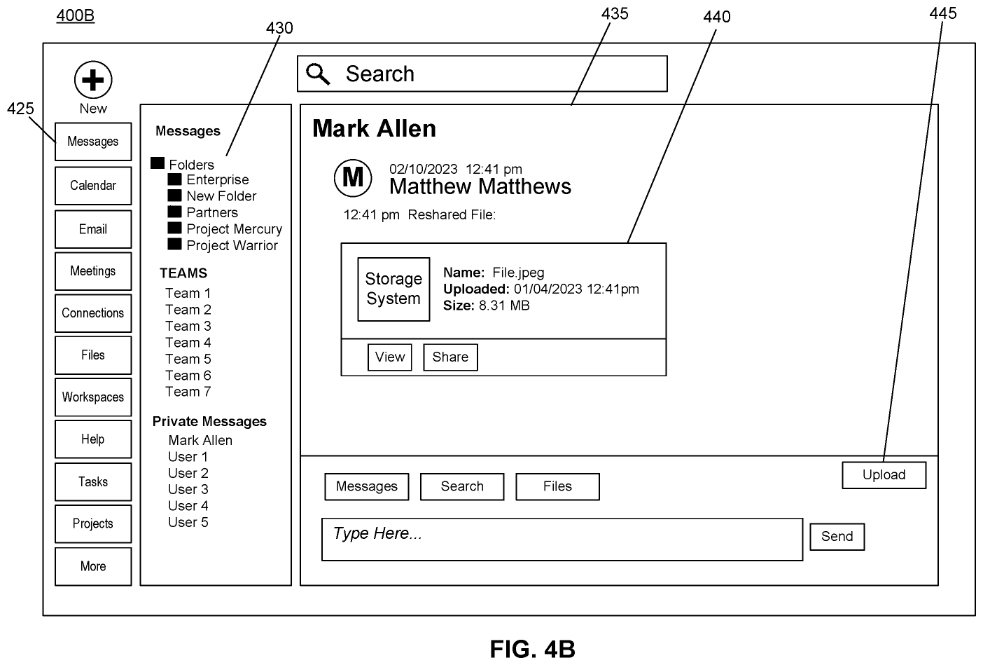

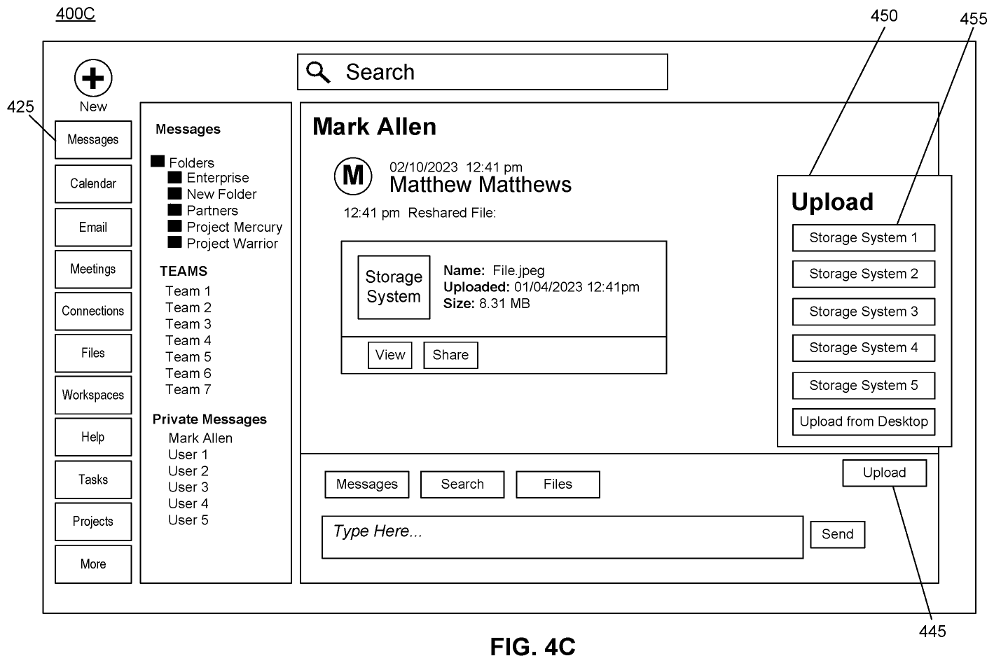

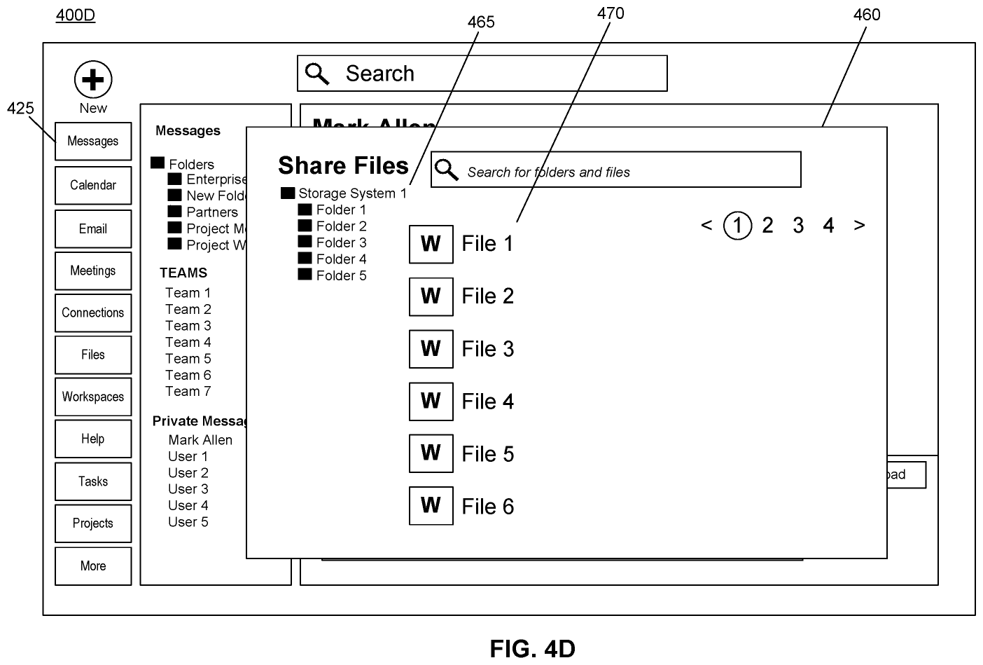

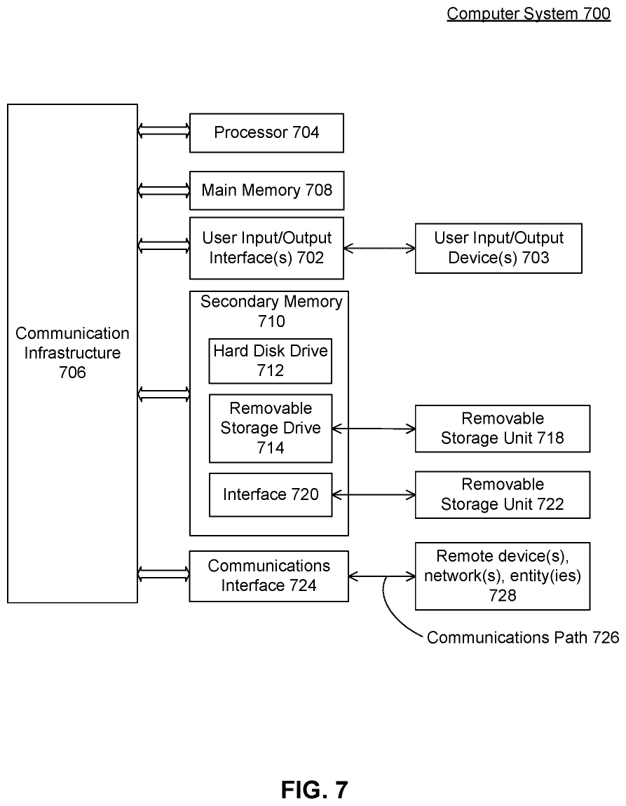

Messaging system 110 may be a computer system such computer system 700 described with reference to FIG. 7. For example, messaging system 110 may be implemented using one or more servers and/or databases. Messaging system 110 may facilitate communications between client devices 150. For example, messaging system 110 may generate graphical user interfaces (GUIs) with workspaces and/or chat panels. Examples of such GUIs are depicted in FIGS. 2A-2D and 4A-4D.

When facilitating communications via chat panels, the messaging system 110 may transmit messages to users subscribed to a particular chat panel. For example, a user subscribed to a particular chat panel may utilize a client device 150 to deliver a message to other subscribed users. An administrator may also use client device 150 to interact with chat panels. A client device 150 may be an electronic device with messaging capabilities, such as, for example, a telephone, tablet, computer, laptop, or other smart devices. Client device 150 may display a graphical user interface for the user to utilize when receiving or delivering messages. The user may use the client device 150 to connect to messaging system 110, which may be configured to instantiate the chat panel. In some embodiments, messaging system 110 instantiates multiple chat panels, allowing many users to subscribe to one or more chat panels. In some embodiments, messaging system 110 is implemented in a web-based platform and client device 150 may use a computer communications protocol to connect to messaging system 110, such as, for example, WebSocket®, HTTP, or BOSH. In an embodiment, client device 150 may install an application to access the chat panels of messaging system 110.

To deliver messages, messaging system 110 may use several components. For example, client device 150 may connect to messaging system 110 via a load balancer. The load balancer may be a standalone server or may be a portion of a server. The load balancer receives a connection request from a client device 150 and determines a messaging server with which to connect the client device 150. In an embodiment where many client devices 150 are attempting to connect to messaging system 110, the load balancer attempts to evenly distribute the connections to different messaging servers. By distributing the connections, stress on individual messaging servers is reduced.

Once connected, a session is open between messaging system 110 and client device 150. The client device 150 and messaging system 110 may communicate via a messaging protocol, such as, for example, WebSocket®. In an embodiment, messaging system 110 may use one or more messaging servers. The messaging servers may be a commercial server, such as, for example Apache Tomcat®.

Once a session is open between a client device 150 and messaging system 110, client device 150 may send messages to and/or receive messages from the connected messaging server. In an embodiment, a user uses client device 150 to send a message to messaging system 110. This message is intended to be received by other users who are subscribed to the same chat panel as the sending user. After the user generates a message at client device 150, client device 150 sends the message to messaging system 110. Messaging system 110 then generates a list of users who are meant to receive the message. In an embodiment, the client device 150 may already generate the list of intended receiving users and send the list and the message to messaging system 110. Messaging system 110 then checks to determine if a receiving user is connected to messaging system 110. Messaging system then sends the message to the user identified on the list of intended receiving users. If a receiving user is connected, messaging system 110 will deliver the message to the receiving user's connected client device 150. This delivery allows for real-time distribution of messages.

If a receiving user is not connected to messaging system 110, the messaging system 110 will store the message in messaging database 118. Messaging database 118 is a database such as a relational database. Messaging servers may communicate with messaging database 118 using a database management system, such as, for example, MySQL®, PostgreSQL®, MongoDB®, or SAP HANA®. Messaging system 110 will then continue to check if the receiving user connects to a messaging server. When a receiving user connects, messaging system 110 retrieves the stored message from messaging database 118 and delivers the message to the receiving user's connected client device.

Using the messaging servers and/or databases, messaging system 110 may facilitate messages exchanged between users using messaging service 112. Messaging service 112 may maintain chat panels and/or groups of conversations between users of messaging system 110. The chat panels may correspond to messages passed between two individuals and/or between more individuals. Messaging service 112 may facilitate instant messaging and/or real-time messaging between users and client devices 150.

Messaging system 110 may also include events service 114 and/or storage service 116. Events service 114 may aid in managing events and/or calendars for a user of messaging system 110. For example, users may define one or more calendars having one or more events. Messaging system 110 may store such data with correspondence to the users in messaging database 118. Events service 114 may also facilitate the creation of events and/or the transmission of invitations to attendees of the event. As will be further explained below, events service 114 may interface with events system 130 to schedule an event and/or transmit an event invitation. For example, events service 114 may retrieve one or more contacts from an events system. Events service 114 may generate an event definition, which may include a list of attendees, location, time, duration, video conference link, description, and/or other information for scheduling an event. Events service 114 may then transmit the event definition to an events system 130 to schedule the event and/or to send invitations. Events service 114 may populate a calendar managed by messaging system 110 and/or events system 130 with the event. Events service 114 may also manage video conference scheduling and/or invitations in the same manner.

Messaging system 110 may also include storage service 116. Storage service 116 may interface with cloud storage systems 140. For example, users of messaging system 110 may view and/or access files and/or data stored on cloud storage system 140 via storage service 116. Storage service 116 may generate one or more GUIs allowing users to interact with these files. Storage service 116 may also facilitate the sharing of these files in chat panels. For example, these may be the sharing of links to the files on cloud storage system 140. In some embodiments, when a user shares a file with another user and/or group of users, storage service 116 may update the permissions of the file at the cloud storage system 140. For example, storage service 116 may update the permission from a restricted permission that blocks access to a read permission or a view permission. In some embodiments, messaging system 110 may adopt the permission set by the cloud storage systems 140.

In some embodiments, messaging system 110 may also store and/or manage files. For example, these files may be stored in messaging database 118. Storage service 116 may also facilitate the storage and/or sharing of these files in chat panels. In some embodiments, client devices 150 may upload files and/or data from a local system for sharing. Storage service 116 may facilitate the uploading of a file by the client devices 150 and/or interface with messaging service 112 to share the uploaded file in a chat panel.

As previously explained, messaging system 110 may interface with one or more events systems 130 and/or cloud storage systems 140. Events systems 130 may correspond to service providers providing event management, calendar management, email messaging, and/or contacts messaging services. Cloud storage systems 140 may correspond to service providers providing file management, document management, and/or other data storage functionality. While the events systems 130 and cloud storage systems 140 are depicted separately in FIG. 1, a particular service provider may be able to perform multiple overlapping functionalities. For example, an events system 130 may be able to also manage file data and/or a cloud storage system 140 may also provide email and/or calendar functionality. In this manner, the terms events system 130 and/or cloud storage system 140 is not intended to limit the functionality of those system and/or the functionality that may be integrated with messaging system 110.

Messaging system 110 may communicate with events system 130 and/or cloud storage system 140 via network 120. Network 120 may include any combination of wired and/or wireless networks, which may include mobile communication networks, Local Area Networks (LANs), Wide Area Networks (WANs), and/or the Internet. Messaging system 110 may use a communication interface to perform this communication. The communication interface may interface with these networks to implement bidirectional communications with one or more events system 130 and/or cloud storage system 140. In some embodiments, the communication interface may be an application programming interface (API) used for communications with events system 130 and/or cloud storage system 140. Messaging system 110 may also communicate with client device 150 via network 120 as well.

FIG. 2A depicts a block diagram of a graphical user interface (GUI) 200A displaying calendar integration, according to some embodiments. Messaging system 110 may generate GUI 200A for display on client devices 150. GUI 200A may include a calendar button 205, calendar identifiers 210, a calendar display 215, and/or a login button 220. Calendar button 205 may be part of a toolbar allowing for navigation between different functionality offered by messaging system 110. Upon selecting calendar button 205, calendar identifiers 210, calendar display 215, and/or login button 220 may be displayed.

Calendar identifiers 210 may identify one or more calendars that may be displayed in calendar display 215. For example, the calendars may be personal to the user and/or may have been shared from another user. In some embodiments, messaging system 110 may have retrieved the calendars and/or the corresponding calendar events or calendar appointments from an events system 130. For example, a user of messaging system 110 may have used messaging system 110 to log into a particular events system 130. This may occur via credentials supplied to events system 130 and/or via a single sign-on process. Messaging system 110 may then populate calendar display 215 with the corresponding calendar data.

Calendar identifiers 210 may include GUI objects such as a checkbox allowing users to show or hide a particular calendar. For example, a calendar having a calendar identifier 210 labeled as “Birthdays” may have a corresponding checkbox. When the checkbox is checked, calendar display 215 may display the events corresponding to the “Birthdays” calendar. When the checkbox is unchecked, the events may not be displayed in calendar display 215.

Calendar display 215 may include one or more views to identify dates and/or times. For example, this may include a day view, a week view, a work week view, a month view, and/or other views. Calendar display 215 may include slots indicating whether a particular time is occupied by an event. The events corresponding to calendar identifiers 210 that have been selected may be displayed using calendar display 215. In this manner, calendar display 215 may display calendars managed by messaging system 110 and/or calendars retrieved from an events system 130. Users may interact with, view, and/or modify these events. When an event managed by an events system 130 is modified within messaging system 110, messaging system 110 may transmit a command, such as an API command, to the events system 130. This command may instruct the events system 130 to update the corresponding calendar with the modification. Example modifications may include changing a date, time, location, description, and/or invitees to the event.

GUI 200A may also include login button 220. Selection of login button 220 may initiate a login process with a particular events system 130. This login process may allow a user to provide credentials and/or select a particular account to use from the events system 130. As further explained below, after logging in, messaging system 110 may retrieve contacts and/or event data from events system 130 for populating calendar display 215. Upon selecting login button 220, messaging system 110 may display GUI 200B as described with reference to FIG. 2B.

FIG. 2B depicts a block diagram of a graphical user interface (GUI) 200B displaying integration with an events system 130, according to some embodiments. Messaging system 110 may generate GUI 200B for display on client devices 150. GUI 200B may include login button 220 as described with reference to GUI 200A. GUI 200B may also include events login display 225, saved account identifier 230, and/or other account identifier 235.

When a user selects login button 220, messaging system 110 may display events login display 225. If a user has previously logged into an events system 130 via messaging system 110, events login display 225 may include saved account identifier 230. Saved account identifier 230 may identify an account corresponding to the events system 130. The user may have previously provided events system 130 login credentials in order to access events system 130 via messaging system 110. Messaging system 110 may also have access to the calendars and/or calendar events corresponding to the events system 130 account. For example, messaging system 110 may import a copy of the calendar from the events system 130 to the messaging system 110.

If a user wishes to use another account and/or to add a new account, the user may select other account identifier 235. The selection of this GUI object may cause messaging system 110 to execute a login process with an events system 130. This login process may include providing additional credentials and/or using a multiple factor authentication to add the account for use on messaging system 110. The added account may be an account managed by and/or created by events system 130. In this manner, a user may have an account corresponding to messaging system 110. Messaging system 110 may link the account corresponding to events system 130 with this account to allow the user to access events system 130 via messaging system 110. This access may allow for the retrieval of contacts and/or calendar event information.

The linking may also allow a user to create an event using messaging system 110 to be scheduled using event system 130. As further described below, a user may define an event using GUI 200C. The user may also search for and/or identify contacts to be invited to the event from within messaging system 110. The contacts may have been retrieved from event system 130. Upon defining the details of the event, the messaging system 110 may transmit the event details to event system 130.

FIG. 2C depicts a block diagram of a graphical user interface (GUI) 200C displaying a new event creation page, according to some embodiments. Messaging system 110 may generate GUI 200C for display on client devices 150. GUI 200C may include one or more fields allowing a user to define information related to an event. The event may be, for example, a calendar event or appointment. Event details which may be provided may include an event name, an event location, a reminder, a user status during the event, a start time and/or date, an end time and/or date, an identification of whether the event repeats, an option to provide a video conference link to the event, a description field, and/or a field to invite contacts. GUI 200C may also include a select provider object 240, a calendar name object 245, a video conference toggle 250, and/or an invitee display 255.

Select provider object 240 may be a GUI object allowing a user to select a particular events system 130 to generate the event. For example, this may be a drop-down menu. The user may have previously logged into one or more events systems 130 via messaging system 110. The user may designate the desired events system 130 to create the event and/or send invitations to the event to other recipients. Based on this designation, messaging system 110 may transmit the event definition to the selected events system 130. The messaging system 110 may also instruct the selected events system 130 to transmit invitation messages to the identified recipients. The invitation messages may include the defined event details.

Calendar name object 245 may allow a user to select a particular calendar to associate with the event. For example, the user may have multiple calendars which may be managed by an events system 130 and/or messaging system 110. Using calendar name object 245, the user may select a particular calendar. For example, this may be a drop-down menu. The selected calendar may store the event such that when the user views the selected calendar, the event and/or event details will appear. If the selected calendar is managed by the events system 130, messaging system 110 may transmit instructions to the events system 130 to add the generated event and/or event details to the selected calendar.

Video conference toggle 250 may allow a user to add a video conference link to the event. When selected, messaging system 110 may generate a video conference link and/or include the video conference link in the description of the event. Messaging system 110 may transmit the video conference link to the selected events system 130 to deliver along with the invitation messages. Messaging system 110 may facilitate the video conference when the meeting is occurring as well.

Invitee display 255 may allow a user to select invitees to attend the event. This may be a search bar used to search contact records corresponding to messaging system 110 and/or events system 130. For example, as text strings are entered, messaging system 110 may perform a search to identify contact records corresponding to the text string. This search may be of contact records stored in messaging database 118 and/or of contacts managed by events system 130. Contact records matching the text string may be displayed in invitee display 255. Users may then select the invitees to add to the event definition.

Upon selecting the invitees and/or providing the event details, messaging system 110 may generate the event as a data structure and/or file. Messaging system 110 may transmit the event definition to the selected events system 130 for transmission to the selected invitees.

FIG. 2D depicts a block diagram of a graphical user interface (GUI) 200D displaying video conference invitation page, according to some embodiments. Messaging system 110 may generate GUI 200D for display on client devices 150. GUI 200D may include video conference invitation display 260, contact search bar 265, filters 270, search results 275, and/or added invitees 280. Messaging system 110 may facilitate video conferences. When initiating a video conference, a user may use video conference invitation display 260 to search for and/or select invitees. For example, a user may input a text string into contact search bar 265. Using this text string, messaging system 110 may search for corresponding contact records. Messaging system 110 may search contact records stored in messaging database 118 and/or across one or more events systems 130. Messaging system 110 may display the search results 275 in video conference invitation display 260.

Users may select search results 275 to add to the list of added invitees 280. For example, the search results 275 may include a name and/or email address corresponding to the contact record. Upon selecting a result, a checkbox may be filled to visualize that the particular contact record has been selected. Messaging system 110 may also display the selected invitees in the added invitees 280 portion of video conference invitation display 260. This may allow the user to continue searching for additional invitees while seeing the invitees that have already been selected.

When the user has selected the invitees, the user may indicate that invitations should be sent. Messaging system 110 may then transmit a video conference link to the invitees. For example, messaging system 110 may transmit identifications of the selected invitees to an events system 130 to transmit the invitations to the video conference. Events system 130 may then transmit the video conference link to the selected invitees based on the corresponding contact information. For example, this may occur via email. In some embodiments, if an invitee is a user of messaging system 110, messaging system 110 may send the invitation to the user. For example, a notification and/or link may be sent via a chat panel to the identified invitee.

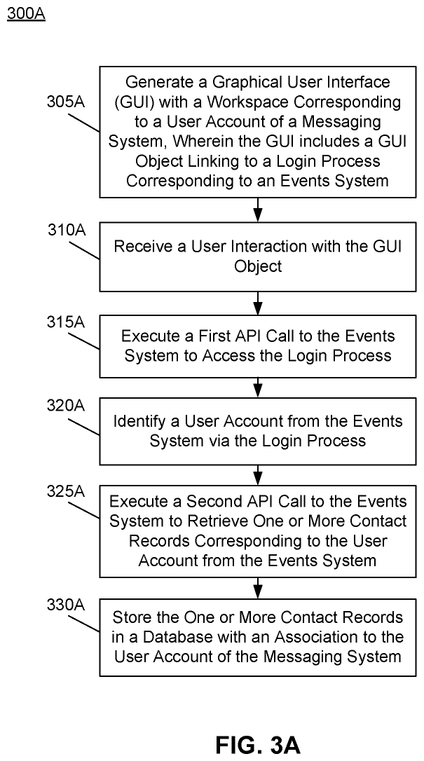

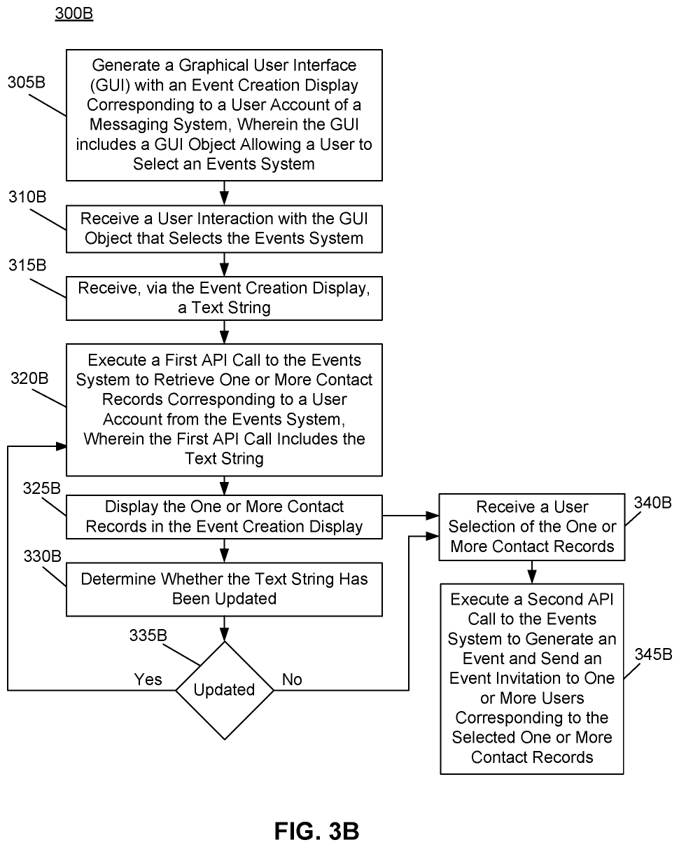

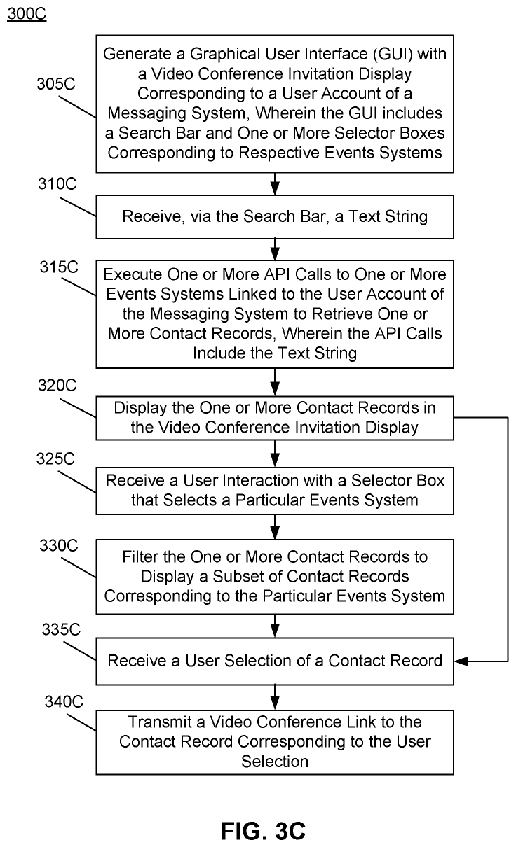

FIG. 3A depicts a flowchart illustrating a method 300A for retrieving contact records, according to some embodiments. Method 300A shall be described with reference to FIG. 1; however, method 300A is not limited to that example embodiment.

In an embodiment, messaging system 110 may utilize method 300A to retrieve contact records from an events system 130. The foregoing description will describe an embodiment of the execution of method 300A with respect to messaging system 110. While method 300A is described with reference to messaging system 110, method 300A may be executed on any computing device, such as, for example, the computer system described with reference to FIG. 7 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3A, as will be understood by a person of ordinary skill in the art.

At 305A, messaging system 110 may generate a graphical user interface (GUI) with a workspace corresponding to a user account of the messaging system 110. The GUI includes a GUI object linking to a login process corresponding to an events system 130. For example, the GUI object may be login button 220 as described with reference to FIGS. 2A and 2B.

At 310A, messaging system 110 may receive a user interaction with the GUI object. For example, a user may select login button 220. The selection may be a mouse click and/or a touch screen selection. This selection may indicate a desire to login to events system 130 via messaging system 110. For example, the user may wish to provide login credentials to events system 130 to link a user account from events system 130 with a user account corresponding to messaging system 110.

At 315A, messaging system 110 may execute a first API call to the events system 130 to access the login process. In some embodiments, an account may have not been previously identified. In this case, the first API call may retrieve one or more webpages and/or GUIs provided by events system 130 to perform a login process. For example, the login process may request login credentials, such as a username and/or password. In some embodiments, the login process may also include a two-factor authentication process. Some examples may include a text message or email passcode. The first API call may instruct the events system 130 to perform the login process. When the login process is completed, events system 130 may return a token or cookie to messaging system 110 indicating that the login was successful. Messaging system 110 may store the token or cookie in messaging database 118.

In some embodiments, when the user has already logged in to the events system 130, the first API call may include the token or cookie. For example, messaging system 110 may transmit the token or cookie as part of the login process.

At 320A, messaging system 110 may identify a user account from events system 130 via the login process. For example, after the user logs in to events system 130, messaging system 110 may identify the corresponding user account. For example, this may be displayed as shown in FIG. 2B. This user account may be identified as corresponding to the token or cookie provided by the events system 130.

At 325A, messaging system 110 may execute a second API call to the events system 130 to retrieve one or more contact records corresponding to the user account from the events system 130. For example, messaging system 110 may retrieve contacts corresponding to an email account managed by events system 130. In some embodiments, the retrieved contact records may include those saved by the user. The contact records may include contact records of users corresponding to recipients of messages sent by the user and/or senders of messages received by the user. In this manner, messaging system 110 may retrieve contact information from events system 130 corresponding to the user account managed by events system 130.

At 330A, messaging system 110 may store the one or more contact records in a database with an association to the user account of the messaging system 110. For example, messaging system 110 may store the one or more contact records in a messaging database 118. In this manner, a user may import contact records from an events system 130 into messaging system 110. These contact records may be used for transmitting event invitations and/or video conference invitations. In some embodiments, messaging system 110 may retrieve these contact records in response to search strings being entered within an event creation display and/or a video conference invitation display. Method 300A may be repeated for one or more events systems 130 to retrieve and/or store contact records.

FIG. 3B depicts a flowchart illustrating a method 300B for sending an event invitation, according to some embodiments. Method 300B shall be described with reference to FIG. 1; however, method 300B is not limited to that example embodiment.

In an embodiment, messaging system 110 may utilize method 300B to generate and/or send an event invitation via events system 130. The foregoing description will describe an embodiment of the execution of method 300B with respect to messaging system 110. While method 300B is described with reference to messaging system 110, method 300B may be executed on any computing device, such as, for example, the computer system described with reference to FIG. 7 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3B, as will be understood by a person of ordinary skill in the art.

At 305B, messaging system 110 may generate a graphical user interface (GUI) with an event creation display corresponding to a user account of messaging system 110. The GUI includes a GUI object allowing a user to select an events system 130. For example, the GUI may be GUI 200C and the GUI object may be select provider object 240 as described with reference to FIG. 2C.

At 310B, messaging system 110 may receive a user interaction with the GUI object that selects the events system. For example, the user may select an events system 130 from a drop down menu provided by select provider object 240.

At 315B, messaging system 110 may receive, via the event creation display, a text string. For example, the user may enter one or more characters to search for invitees to the event. The user may enter the text string via a search bar in invitee display 255. This may search for invitees in a list of contacts managed by events system 130.

At 320B, messaging system 110 may execute a first API call to the events system 130 to retrieve one or more contact records corresponding to a user account from the events system 130. The first API call may include the text string. Using the text string, the events system 130 may return one or more corresponding contact records. For example, these may be names and/or email addresses corresponding to the user account managed by the events system 130. Contact records may also include other information such as an image, a phone number, an email address, a geographic address, title, and/or other data corresponding to an individual. Messaging system 110 may receive this information from events system 130.

At 325B, messaging system 110 may display the one or more contact records in the event creation display. For example, the returned contact records may be displayed in a list. In some embodiments, the list may be a subset of the returned one or more contact records. This may depend on the sizing of GUI 200C. The amount of information may also be varied. For example, the displayed one or more contact records may include an image, a name, an email address, and/or other contact information. The one or more contact records may be selectable.

In some embodiments, messaging system 110 may remove duplicate contact records from display. For example, if multiple contact records have been retrieved across multiple events systems, messaging system 110 may remove the duplicates prior to displaying the contact records in the event creation display. For example, messaging system 110 may display a single contact record corresponding to a particular email address or name. This may occur when multiple events systems 130 are searched and/or when messaging system 110 also stores contact records that may be searched.

At 330B, messaging system 110 may determine whether the text string has been updated. For example, this may occur if the user modifies or edits the text string. The user may add additional characters to search for a contact record. At 335B, if the text string has been updated, the messaging system 110 may return to 320B. Messaging system 110 may execute another API call with the updated text string to receive additional contact records. If the text string has not been updated, messaging system 110 may proceed to 340B.

At 340B, messaging system 110 may receive a user selection of the one or more contact records. The user may select one or more of the contact records via a mouse click and/or a tap. In some embodiments, a user may select a displayed contact record and then continue to search for additional contacts to add to the event. For example, a user may input additional text strings, which may be provided to the events system 130 to retrieve additional search records. Once the user has selected the desired contacts to invite to the event, the user may indicate that invitations should be sent.

At 345B, messaging system 110 may execute a second API call to the events system 130 to generate an event and send an event invitation to one or more users corresponding to the selected one or more contact records. The event may be based on event details provided by the user as described with reference to FIG. 2C. Messaging system 110 may provide the event details and/or identifications of the selected contact records to events system 130. In some embodiments, messaging system 110 may also provide invitee information such as email addresses corresponding to invitees not managed by events system 130. The second API call may instruct events system 130 to generate the event in a calendar managed by events system 130. Events system 130 may also transmit event invitations to the specified contacts. The event invitations may be email messages with event definition information. Messaging system 110 may also store the event in a copy of a calendar imported from the events system 130.

In some embodiments, messaging system 110 may also modify events. For example, the user may modify event details and/or the invitees for an event. Messaging system 110 may execute additional API calls to modify events as well. The API calls may instruct events system 130 to modify the event and/or indicate how the event is to be modified.

FIG. 3C depicts a flowchart illustrating a method 300C for sending a video conference invitation, according to some embodiments. Method 300C shall be described with reference to FIG. 1; however, method 300C is not limited to that example embodiment.

In an embodiment, messaging system 110 may utilize method 300C to invite attendees to a video conference. The foregoing description will describe an embodiment of the execution of method 300C with respect to messaging system 110. While method 300C is described with reference to messaging system 110, method 300C may be executed on any computing device, such as, for example, the computer system described with reference to FIG. 7 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3C, as will be understood by a person of ordinary skill in the art.

At 305C, messaging system 110 may generate a graphical user interface (GUI) with a video conference invitation display corresponding to a user account of messaging system 110. The GUI may include a search bar and one or more selector boxes corresponding to respective events systems. The GUI may be, for example, GUI 200D as described with reference to FIG. 2D. The video conference invitation display may be video conference invitation display 260, the search bar may be contact search bar 265, and/or the one or more selector boxes may correspond to filters 270.

At 310C, messaging system 110 may receive, via the search bar, a text string. For example, the user may enter one or more characters to search for invitees to the video conference. The user may enter the text string via contact search bar 265. This may search for invitees in a list of contacts managed by one or more events system 130.

At 315C, messaging system 110 may execute one or more API calls to one or more events systems 130 linked to the user account of the messaging system 110 to retrieve one or more contact records, wherein the API calls include the text string. Using the text string, one or more events system 130 may return one or more corresponding contact records. For example, these may be names and/or email addresses corresponding to the user account managed by the events system 130. Contact records may also include other information such as an image, a phone number, an email address, a geographic address, title, and/or other data corresponding to an individual. Messaging system 110 may receive this information from events system 130.

At 320C, messaging system 110 may display the one or more contact records in the video conference invitation display 260. For example, the returned contact records may be displayed in a list. In some embodiments, the list may be a subset of the returned one or more contact records. This may depend on the sizing of GUI 200D. The amount of information may also be varied. For example, the displayed one or more contact records may include an image, a name, an email address, and/or other contact information. The one or more contact records may be selectable.

In some embodiments, messaging system 110 may remove duplicate contact records from display. For example, if multiple contact records have been retrieved across multiple events systems, messaging system 110 may remove the duplicates prior to displaying the contact records in the event creation display. For example, messaging system 110 may display a single contact record corresponding to a particular email address or name. This may occur when multiple events systems 130 are searched and/or when messaging system 110 also stores contacts records that may be searched.

At 325C, messaging system 110 may receive a user interaction with a selector box that selects a particular events system 130. For example, the user may select a filter 270 to select a particular events system 130 and/or the messaging system. This selection may indicate the desired system's contacts that the user wishes to view. For example, a user may select a checkbox by a particular events system 130.

At 330C, messaging system 110 may filter the one or more contact records to display a subset of contact records corresponding to the particular events system 130. This filtering may reduce the list of corresponding search results 275 displayed on video conference invitation display 260. The displayed search results 275 may correspond to the selected events system 130.

At 335C, messaging system 110 may receive a user selection of a contact record. This selection may be received from the one or more contact records displayed at 320C and/or from the one or more contact records displayed at 330C. The user may select one or more of the contact records via a mouse click and/or a tap. In some embodiments, a user may select a displayed contact record and then continue to search for additional contacts to invite to the video conference. For example, a user may input additional text strings, which may be provided to the events system 130 to retrieve additional search results 275. Once the user has selected the desired contacts to invite to the video conference, the user may indicate that invitations should be sent.

At 340C, messaging system 110 may transmit a video conference link to the contact record corresponding to the user selection. In some embodiments, messaging system 110 may message the video conference link to a recipient via a chat panel. In some embodiments, messaging system 110 may execute an API call to the events system 130 to generate a message including the video conference link and/or to send the message to the selected one or more contact records. Messaging system 110 may provide the identifications of the selected contacts records to events system 130. In some embodiments, messaging system 110 may also provide invitee information such as email addresses corresponding to invitees not managed by events system 130. The API call may instruct events system 130 to generate the invitation message with the video conference link.

FIG. 4A depicts a block diagram of a graphical user interface (GUI) 400A displaying files from cloud storage systems 140, according to some embodiments. Messaging system 110 may generate GUI 400A for display on client devices 150. GUI 400A may include files button 405, folder identifiers 410, a search bar 415, and/or a file display 420. Files button 405 may be part of a toolbar allowing for navigation between different functionality offered by messaging system 110. Upon selecting files button 405, folder identifiers 410 and/or a file display 420 may be displayed. In some embodiments, a search bar 415 may be present across multiple GUI views provided by messaging system 110.

Folder identifiers 410 may identify one or more cloud storage systems 140 and/or folders. In some embodiments, messaging system 110 may have associated the one or more cloud storage systems 140 based on a log in process to identify one or more accounts corresponding to the cloud storage systems 140. For example, a user of messaging system 110 may have used messaging system 110 to log into the cloud storage systems 140. This may occur via credentials supplied to cloud storage systems 140 and/or via a single sign-on process. Messaging system 110 may also retrieve folder information from each of the storage systems. Messaging system 110 may then populate the folder identifiers 410 with the corresponding folder data. In some embodiments, these may display nested folders and/or folders stored locally at messaging system 110, which may organize files stored local to messaging system 110.

File display 420 may include one or more icons corresponding to files and/or folders. The displayed files and/or folders may correspond to the selected cloud storage system 140 chosen using folder identifiers 410. By interacting with the folder icons within file display 420, a user may explore the file contents of the folder. By interacting with the file icons, the user may choose to share the file with another user. For example, when a user selects, clicks, taps, or interacts with a particular file, a menu may be displayed. The menu may allow the user to identify another user of messaging system 110. For example, a list of users and/or a search bar may be available for the user to identify a recipient. When the user selects a recipient for sharing the file, messaging system 110 may transmit a link to the file in a chat panel to the recipient. The link may link to the file as stored and/or maintained by the cloud storage system 140.

In some embodiments, messaging system 110 may update the permissions corresponding to the file when the file is shared. For example, messaging system 110 may update the permission from a restricted permission that blocks access to a read permission or a view permission. Messaging system 110 may instruct cloud storage system 140 to update the permission.

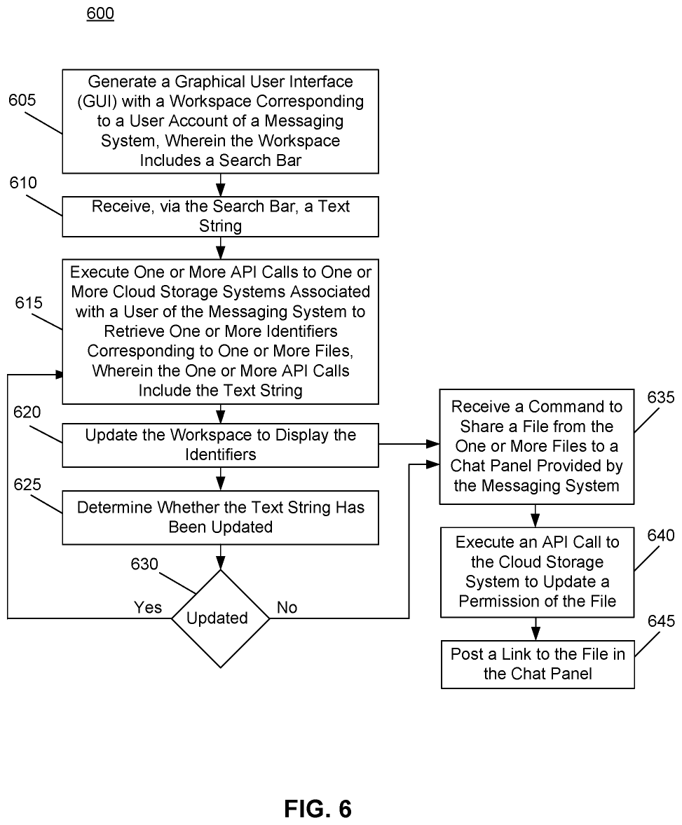

GUI 400A may include search bar 415. Search bar 415 may allow for searches between one or more cloud storage systems 140 and/or of folders and files stored on messaging system 110. Search results may be presented with the corresponding source where the file is stored. For example, a particular search result may indicate a file name and/or a particular cloud storage system 140 where the file is stored. The search bar 415 functionality is further described with reference to FIG. 6.

FIG. 4B depicts a block diagram of a graphical user interface (GUI) 400B displaying a chat panel with a shared file, according to some embodiments. Messaging system 110 may generate GUI 400B for display on client devices 150. GUI 400B may include messages button 425, chat panel identifiers 430, chat panel 435, shared file message 440, and/or upload file button 445. Messages button 425 may be part of a toolbar allowing for navigation between different functionality offered by messaging system 110. Upon selecting messages button 425, chat panel identifiers 430, chat panel 435, shared file message 440, and/or upload file button 445 may be displayed.

Messaging system 110 may facilitate chat and/or instant messaging between users. To select a particular chat panel for communication, the user may select a chat panel identifier 430. The chat panel identifiers 430 may include private messages and/or messages to groups of users, such as teams. A user may share a chat panel 435 with one or more other users and/or communicate via chat panel 435. Chat panel 435 may be a private messaging chat panel, a private group chat panel, a team chat panel, a division chat panel, and/or an organization-wide or company chat panel. Users may share files within chat panel 435. To share a file, the user may have selected a particular file from file display 420 as discussed with reference to FIG. 4A. The user may have then specified a particular user and/or chat panel 435 for sharing the file. Messaging system 110 may then post a link to the file in chat panel 435. This link may appear as shared file message 440.

Shared file message 440 may be a post and/or chat message inserted into chat panel 435 by messaging system 110. Shared file message 440 may be a selectable button with a link to the shared file. In some embodiments, shared file message 440 may display metadata corresponding to the file. For example, shared file message 440 may include a file name, an uploaded time and/or data, a file size, and/or an indication of the storage system storing the file. By selecting and/or interacting with shared file message 440, subscribers to the chat panel 435 may view, access, and/or share the file. The shared file message 440 may include a GUI button allowing the user to re-share the file to another chat panel. For example, after selecting the button, messaging system 110 may display contacts managed by messaging system 110 for the user to re-share file. In some embodiments, a user who has shared the shared file message 440 may delete the shared file message 440 from the chat panel. In this case, messaging system 110 may delete the shared file message 440 from appearing in the chat panels accessed by subscribers as well. Messaging system 110 may remove the link from chat panels corresponding to recipients of messages from the chat panel.

In some embodiments, chat panel 435 may include additional controls for manipulating a workspace. For example, chat panel 435 may be organized as a tab that may be rearranged with other tabs. A user may lock and/or unlock a tab to reorganize the relative positions of the tabs. A locked tab and/or locked chat panel 435 may maintain a particular position. In some embodiments, chat panel 435 may include a muting option. For example, a user may mute a particular chat panel for a set amount of time and/or indefinitely. Muting may turn off notifications for the particular chat panel. In some embodiments, a user may mute all chat panels. A user may also set a status corresponding to the chat panel. In this manner, messaging system 110 may allow for the muting of particular chat panels and not others and/or set a timer specific to each chat panel.

Returning to the sharing of a file, a user may be viewing chat panel 435 and wish to share a file. The user may select upload file button 445 to share a file from within chat panel 435. Upon selecting upload file button 445, messaging system 110 may display GUI 400C as described with reference to FIG. 4C.

FIG. 4C depicts a block diagram of a graphical user interface (GUI) 400C displaying an upload GUI object 450, according to some embodiments. Upload GUI object 450 may be displayed in response to a user selecting upload file button 445. Upload GUI object 450 may include one or more storage selection buttons 455. The storage selection buttons 455 may allow a user to select a particular cloud storage system 140, messaging system 110, and/or an upload from client device 150. Upon selecting a storage selection button 455, messaging system 110 may generate GUI 400D as described with reference to FIG. 4D.

FIG. 4D depicts a block diagram of a graphical user interface (GUI) 400D displaying files for uploading, according to some embodiments. Messaging system 110 may generate GUI 400D for display on client devices 150. GUI 400D may include file selection panel 460, folder identifiers 465, and/or file identifiers 470. File selection panel 460 may be displayed in response to a user selection a storage selection button 455 as described with reference to FIG. 4C. File selection panel may display files managed by the particular cloud storage system 140 selected. A user may navigate between folders of the selected cloud storage system 140 using folder identifiers 465.

When a user selects a particular file identifier 470, messaging system 110 may post a link to the selected file to the chat panel. Other users subscribed to the chat panel may receive a link to the selected file as described with reference to FIG. 4B. In some embodiments, messaging system 110 may update the permissions at the cloud storage system 140 when a user selects a particular file to share. For example, messaging system 110 may update the permission from a restricted permission that blocks access to a read permission or a view permission. Messaging system 110 may instruct cloud storage system 140 to update the permission. In some embodiments, messaging system 110 may generate a GUI allowing the user to set a permission of the file. For example, the GUI may be generated based on GUI components and/or retrieved from cloud storage system 140.

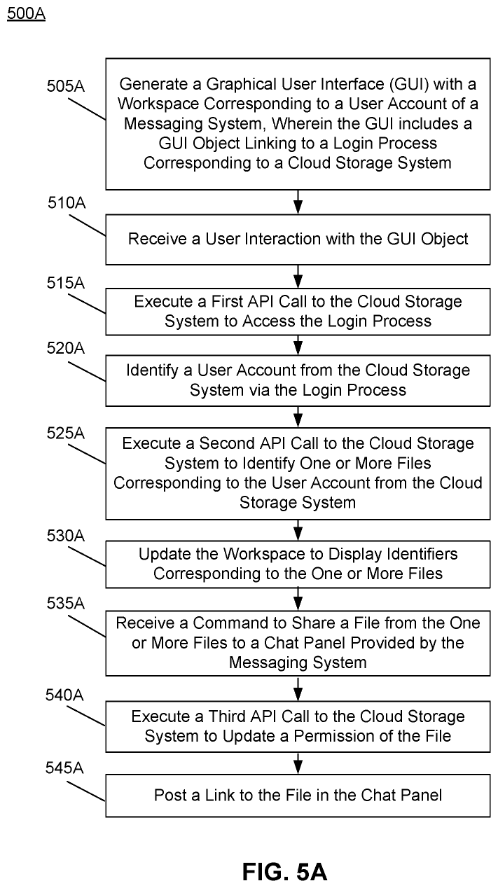

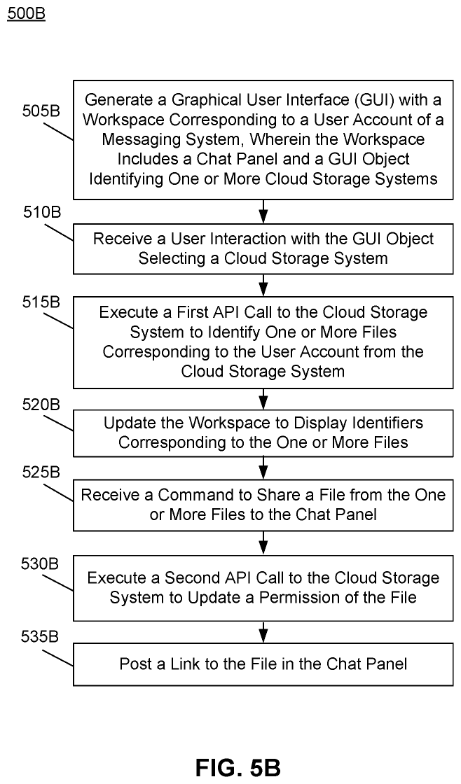

FIG. 5A depicts a flowchart illustrating a method 500A for posting a link to a chat panel, according to some embodiments. Method 500A shall be described with reference to FIG. 1; however, method 500A is not limited to that example embodiment.

In an embodiment, messaging system 110 may utilize method 500A to post a file link to a chat panel. The foregoing description will describe an embodiment of the execution of method 500A with respect to messaging system 110. While method 500A is described with reference to messaging system 110, method 500A may be executed on any computing device, such as, for example, the computer system described with reference to FIG. 7 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 5A, as will be understood by a person of ordinary skill in the art.

At 505A, messaging system 110 may generate a graphical user interface (GUI) with a workspace corresponding to a user account of the messaging system 110. The GUI includes a GUI object linking to a login process corresponding to a cloud storage system 140. For example, the GUI object may be similar to login button 220 as described with reference to FIGS. 2A and 2B. This button may appear when a user has selected files button 405 as described with reference to FIG. 4A.

At 510A, messaging system 110 may receive a user interaction with the GUI object. For example, a user may select a login button similar to login button 220. The selection may be a mouse click and/or a touch screen selection. This selection may indicate a desire to login to a particular cloud storage system 140 via messaging system 110. For example, the user may wish to provide login credentials to cloud storage system 140 to link a user account from cloud storage system 140 with a user account corresponding to messaging system 110.

At 515A, messaging system 110 may execute a first API call to the cloud storage system 140 to access the login process. In some embodiments, an account may have not been previously identified. In this case, the first API call may retrieve one or more webpages and/or GUIs provided by cloud storage system 140 to perform a login process. For example, the login process may request login credentials, such as a username and/or password. In some embodiments, the login process may also include a two-factor authentication process. Some examples may include a text message or email passcode. The first API call may instruct the cloud storage system 140 to perform the login process. When the login process is completed, cloud storage system 140 may return a token or cookie to messaging system 110 indicating that the login was successful. Messaging system 110 may store the token or cookie in messaging database 118.

In some embodiments, when the user has already logged in to the cloud storage system 140, the first API call may include the token or cookie. For example, messaging system 110 may transmit the token or cookie as part of the login process.

At 520A, messaging system 110 may identify a user account from the cloud storage system 140 via the login process. For example, after the user logs in to cloud storage system 140, messaging system 110 may identify the corresponding user account. Identifiers corresponding to folders and/or files corresponding to the user account may be retrieved and/or displayed as shown in FIG. 4A. This user account may be identified as corresponding to the token or cookie provided by the cloud storage system 140.

At 525A, messaging system 110 may execute a second API call to the cloud storage system 140 to identify one or more files corresponding to the user account from the cloud storage system 140. For example, as described with reference to FIG. 4A, messaging system 110 may display folder and/or file designations to allow a user to browse the content of the corresponding cloud storage system 140. These identifiers may correspond to one or more files and/or folders stored by cloud storage system 140. For example, a user may have previously signed into cloud storage system 140 and stored these files. In some embodiments, the files and/or documents may have been shard with the user on cloud storage system 140. For example, the documents may have been uploaded to cloud storage system 140 and/or created within cloud storage system 140.

At 530A, messaging system 110 may update the workspace to display identifiers corresponding to the one or more files. The identifiers may be similar to the file icons described with reference to FIG. 4A. By interacting with the file icons, the user may choose to share the file with another user.

At 535A, messaging system 110 may receive a command to share a file from the one or more files to a chat panel provided by the messaging system 110. For example, when a user selects, clicks, taps, or interacts with a particular file, a menu may be displayed. The menu may allow the user to identify another user of messaging system 110. For example, a list of users and/or a search bar may be available for the user to identify a recipient. When the user selects a recipient for sharing the file, messaging system 110 may transmit a link to the file in a chat panel to the recipient. The link may link to the file as stored and/or maintained by the cloud storage system 140. In some embodiments, the user may select a team chat panel and/or a private message chat panel.

At 540A, messaging system 110 may execute a third API call to the cloud storage system 140 to update a permission of the file. For example, messaging system 110 may update the permission from a restricted permission that blocks access to a read permission or a view permission. Messaging system 110 may instruct cloud storage system 140 to update the permission via the third API call. In some embodiments, the permission may be tied to the link generated. For example, individual with access to the link may view and/or access the file. In some embodiments, the permission may allow downloading of the file and/or editing of the file. If the permission of the file already allows for access, for example, by viewing and/or accessing, messaging system 110 may not need to update the permission for the file.

At 545A, messaging system 110 may post a link to the file in the chat panel. For example, the link to the file may be posted in chat panel 435 as described with reference to FIG. 4B. When the user selects a recipient for sharing the file, messaging system 110 may transmit a link to the file in a chat panel to the recipient. The link may link to the file as stored and/or maintained by the cloud storage system 140. In some embodiments, the user may select a team chat panel and/or a private message chat panel.

FIG. 5B depicts a flowchart illustrating a method 500B for posting a link to a chat panel from within the chat panel, according to some embodiments. Method 500B shall be described with reference to FIG. 1; however, method 500B is not limited to that example embodiment. In an embodiment, messaging system 110 may utilize method 500B to post a file link to a chat panel. For example, the user may decide to share a file from within the chat panel. The foregoing description will describe an embodiment of the execution of method 500B with respect to messaging system 110. While method 500B is described with reference to messaging system 110, method 500B may be executed on any computing device, such as, for example, the computer system described with reference to FIG. 7 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 5B, as will be understood by a person of ordinary skill in the art.

At 505B, messaging system 110 may generate a graphical user interface (GUI) with a workspace corresponding to a user account of the messaging system 110. The GUI includes a chat panel and a GUI object identifying one or more cloud storage systems 140. For example, the chat panel may be similar to chat panel 435. The GUI object may similar to upload GUI object 450 as described with reference to FIG. 4C. Upload GUI object 450 may be displayed in response to a user selecting upload file button 445. Upload GUI object 450 may include one or more storage selection buttons 455. The storage selection buttons 455 may allow a user to select a particular cloud storage system 140, messaging system 110, and/or an upload from client device 150.

At 510B, messaging system 110 may receive a user interaction with the GUI object selecting a cloud storage system 140. For example, a user may select a particular storage selection button 455 to select a particular cloud storage system 140.

At 515B, messaging system 110 may execute a first API call to the cloud storage system 140 to identify one or more files corresponding to the user account from the cloud storage system 140. For example, as described with reference to FIG. 4D, messaging system 110 may display folder and/or file designations to allow a user to browse the content from the selected cloud storage system 140. These identifiers may correspond to one or more files and/or folders stored by cloud storage system 140. For example, a user may have previously signed into cloud storage system 140 and stored these files. In some embodiments, the files and/or documents may have been shard with the user on cloud storage system 140. For example, the documents may have been uploaded to cloud storage system 140 and/or created within cloud storage system 140.

At 520B, messaging system 110 may update the workspace to display identifiers corresponding to the one or more files. The identifiers may be similar to the file icons described with reference to FIG. 4D. By interacting with the file icons, the user may choose to share the file with one or more users of the chat panel. This may be the underlying chat panel 435 that the user used to access the files stored by cloud storage system 140.

At 525B, messaging system 110 may receive a command to share a file from the one or more files to the chat panel. For example, when a user selects, clicks, taps, or interacts with a particular file, messaging system 110 may post a link to the file in the chat panel being accessed by the user. The link may link to the file as stored and/or maintained by the cloud storage system 140. As previously explained, the chat panel 435 may be a team chat panel and/or a private message chat panel. Users subscribed to the chat panel may access the link to access the file.

At 530B, messaging system 110 may execute a second API call to the cloud storage system 140 to update a permission of the file. For example, messaging system 110 may update the permission from a restricted permission that blocks access to a read permission or a view permission. Messaging system 110 may instruct cloud storage system 140 to update the permission via the third API call. In some embodiments, the permission may be tied to the link generated. For example, individual with access to the link may view and/or access the file. In some embodiments, the permission may allow downloading of the file and/or editing of the file. If the permission of the file already allows for access, for example, by viewing and/or accessing, messaging system 110 may not need to update the permission for the file.

At 535B, messaging system 110 may post a link to the file in the chat panel. For example, the link to the file may be posted in chat panel 435 as described with reference to FIG. 4B. When the file is selected to be uploaded from within the chat panel 435, messaging system 110 may post the link to the file in the corresponding chat panel 435. The link may link to the file as stored and/or maintained by the cloud storage system 140. As previously explained, chat panel 435 may be a team chat panel and/or a private message chat panel.

FIG. 6 depicts a flowchart illustrating a method 600 for searching one or more cloud storage systems for a file, according to some embodiments. Method 600 shall be described with reference to FIG. 1; however, method 600 is not limited to that example embodiment.

In an embodiment, messaging system 110 may utilize method 600 to search for files stored on one or more cloud storage systems and/or stored on messaging system 110. The foregoing description will describe an embodiment of the execution of method 600 with respect to messaging system 110. While method 600 is described with reference to messaging system 110, method 600 may be executed on any computing device, such as, for example, the computer system described with reference to FIG. 7 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 6, as will be understood by a person of ordinary skill in the art.

At 605, messaging system 110 may generate a graphical user interface (GUI) with a workspace corresponding to a user account of the messaging system 110. The workspace includes a search bar. For example, the search bar may be search bar 415 as described with reference to FIG. 4A. Search bar 415 may allow for searches between one or more cloud storage systems 140 and/or of folders and files stored on messaging system 110.

At 610, messaging system 110 may receive, via the search bar, a text string. For example, the user may enter one or more characters to search for files stored in one or more cloud storage systems 140. The user may enter the text string via search bar 415. Search bar 415 may be a global search bar that allows for searching across multiple cloud storage systems 140 and/or messaging system 110.

At 615, messaging system 110 may execute one or more API calls to one or more cloud storage systems 140 associated with a user of the messaging system 110 to retrieve one or more identifiers corresponding to one or more files, wherein the one or more API calls include the text string. For example, when messaging system 110 receives the text string, messaging system 110 may identify one or more cloud storage systems 140 where the user has already logged in. For example, the user account corresponding to the messaging system 110 may have been associated with one or more accounts corresponding to cloud storage systems 140. Based on this linking of accounts, messaging system 110 may identify the particular cloud storage systems 140 to receive an API call. The one or more API calls may include a token and/or token corresponding to the logged in user account and/or the text string. In this manner, cloud storage systems 140 may return file and/or document identifiers corresponding to the text string and to the specific user account. In some embodiments, messaging system 110 may allow a user to specify whether the search is to search metadata and/or perform a full content search. Based on the selection, messaging system 110 may include the instruction in the one or more API calls.

At 620, messaging system 110 may update the workspace to display identifiers. The identifiers may correspond to the one or more files identified from the one or more cloud storage systems 140. In some embodiments, search bar 415 may provide a drop down menu displaying the search results. In some embodiments, the identifiers may be similar to the file icons described with reference to FIG. 4A. By interacting with the file icons, the user may choose to share the file with another user. This is further described with reference to 635.

At 625, messaging system 110 may determine whether the text string has been updated. For example, this may occur if the user modifies or edits the text string. The user may add additional characters to search for a file. At 630, if the text string has been updated, the messaging system 110 may return to 615. Messaging system 110 may execute additional API calls with the updated text string to receive additional file identifiers. This may be from one or more cloud storage systems 140. If the text string has not been updated, messaging system 110 may proceed to 635.

At 635, messaging system 110 may receive a command to share a file from the one or more files to a chat panel provided by the messaging system 110. For example, when a user selects, clicks, taps, or interacts with a particular file identifier, a menu may be displayed. The menu may allow the user to identify another user of messaging system 110. For example, a list of users and/or a search bar may be available for the user to identify a recipient. When the user selects a recipient for sharing the file, messaging system 110 may transmit a link to the file in a chat panel to the recipient. The link may link to the file as stored and/or maintained by the cloud storage system 140. In some embodiments, the user may select a team chat panel and/or a private message chat panel.

At 640, messaging system 110 may execute an API call to the cloud storage system 140 to update a permission of the file. For example, messaging system 110 may update the permission from a restricted permission that blocks access to a read permission or a view permission. Messaging system 110 may instruct cloud storage system 140 to update the permission via the API call. In some embodiments, the permission may be tied to the link generated. For example, individual with access to the link may view and/or access the file. In some embodiments, the permission may allow downloading of the file and/or editing of the file. If the permission of the file already allows for access, for example, by viewing and/or accessing, messaging system 110 may not need to update the permission for the file.

At 645, messaging system 110 may post a link to the file in the chat panel. For example, the link to the file may be posted in chat panel 435 as described with reference to FIG. 4B. When the user selects a recipient for sharing the file, messaging system 110 may transmit a link to the file in a chat panel to the recipient. The link may link to the file as stored and/or maintained by the cloud storage system 140. In some embodiments, the user may select a team chat panel and/or a private message chat panel.

Various embodiments may be implemented, for example, using one or more well-known computer systems, such as computer system 700 shown in FIG. 7. One or more computer systems 700 may be used, for example, to implement any of the embodiments discussed herein, as well as combinations and sub-combinations thereof.

Computer system 700 may include one or more processors (also called central processing units, or CPUs), such as a processor 704. Processor 704 may be connected to a communication infrastructure or bus 706.

Computer system 700 may also include user input/output device(s) 703, such as monitors, keyboards, pointing devices, etc., which may communicate with communication infrastructure 706 through user input/output interface(s) 702.

One or more of processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (Saas), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer implemented method, comprising:
generating a graphical user interface (GUI) with an event creation display corresponding to a user account of a messaging system, wherein the GUI includes a GUI object allowing a user to select an events system;
receiving a user interaction with the GUI object that selects the events system;
receiving, via the event creation display, a text string;
executing a first application programming interface (API) call to the events system to retrieve one or more contact records corresponding to a user account from the events system, wherein the first API call includes the text string;
displaying the one or more contact records in the event creation display;
receiving a user selection of the one or more contact records; and
executing a second API call to the events system to generate an event and send an event invitation to the one or more contact records corresponding to the user selection.

2. The computer implemented method of claim 1, wherein the one or more contact records include respective email addresses.

3. The computer implemented method of claim 1, further comprising:
receiving an updated text string;
executing an API call to the events system to retrieve additional contact records from the events system, wherein the API call includes the updated text string; and
displaying the additional contact records in the event creation display.

4. The computer implemented method of claim 1, comprises:
storing the one or more contact records in a database managed by the messaging system.

5. The computer implemented method of claim 1, wherein displaying the one or more contact records in the event creation display further comprises:
removing duplicate contact records from the one or more contact records based on a set of other contact records retrieved from another events system.

6. The computer implemented method of claim 1, further comprising:
importing a copy of a calendar from the events system to the messaging system; and
storing, at the messaging system, the event in the copy of the calendar imported from the events system.

7. The computer implemented method of claim 1, wherein the first API call includes a token indicating that a user of the messaging system has previously completed a login process with the events system.

8. A computer implemented method, comprising:
generating a graphical user interface (GUI) with a video conference invitation display corresponding to a user account of a messaging system, wherein the GUI includes a search bar;
receiving, via the search bar, a text string;
executing one or more application programming interface (API) calls to one or more events systems linked to the user account of the messaging system to retrieve one or more contact records, wherein the one or more API calls include the text string;
displaying the one or more contact records in the video conference invitation display;
receiving a user selection of a contact record from the one or more contact records; and
transmitting a video conference link to the contact record corresponding to the user selection.

9. The computer implemented method of claim 8, wherein transmitting the video conference link further comprises:
executing an API call to an events system corresponding to the user selection to generate a message including the video conference link and to send the message to the contact record.

10. The computer implemented method of claim 8, wherein displaying the one or more contact records further comprises:
receiving a user interaction with a selector box that selects a particular events system; and
filtering the one or more contact records to display a subset of contact records corresponding to the particular events system.

11. A computer implemented method, comprising:
generating a graphical user interface (GUI) with a workspace corresponding to a user account of a messaging system, wherein the GUI includes a GUI object linking a login process corresponding to a cloud storage system;
receiving a user interaction with the GUI object;
executing a first application programming interface (API) call to the cloud storage system to access the login process;
identifying a user account from the cloud storage system via the login process;
executing a second API call to the cloud storage system to retrieve one or more file identifiers corresponding to the user account from the cloud storage system;
updating the workspace to display the one or more file identifiers;
receiving a command to share a file corresponding to a file identifier from the one or more file identifiers to a chat panel provided by the messaging system; and
posting a link to the file corresponding to the file identifier in the chat panel.

12. The computer implemented method of claim 11, further comprising:
executing a third API call to the cloud storage system to update a permission of the file.

13. The computer implemented method of claim 12, wherein the permission of the file is updated to allow viewing of file content.

14. The computer implemented method of claim 11, wherein the chat panel is displayed within the workspace, the method further comprising:
receiving a selection of the cloud storage system from a GUI object within the chat panel;
executing a third API call to the cloud storage system to retrieve the one or more file identifiers corresponding to the user account from the cloud storage system;
updating the workspace to display the one or more file identifiers;
receiving a command to share a second file corresponding to a second file identifier from the one or more file identifiers to the chat panel displayed on the workspace; and
posting a link to the second file corresponding to the second file identifier in the chat panel.

15. The computer implemented method of claim 14, wherein the GUI object displays buttons corresponding to multiple cloud storage systems.

16. The computer implemented method of claim 11, wherein posting the link to the file further comprises:
generating a shared file message including the link to the file and metadata corresponding to the file.

17. The computer implemented method of claim 16, wherein the shared file message includes a GUI button to re-share the file to another chat panel.

18. The computer implemented method of claim 11, further comprising:
receiving a command deleting the link to the file from the chat panel; and
removing the link from chat panels corresponding to recipients of messages from the chat panel.

19. The computer implemented method of claim 11, wherein the workspace includes a search bar, and wherein the method further comprises:
receiving a text string via the search bar;
executing one or more API calls to one or more cloud storage systems associated with the user account of the messaging system to retrieve a second set of one or more file identifiers corresponding to one or more files, wherein the one or more API calls includes the text string;
updating the workspace to display the second set of one or more file identifiers;
receiving a second command to share a second file corresponding to a second file identifier from the second set of one or more file identifiers to the chat panel; and
posting a second link to the second file corresponding to the second file identifier in the chat panel.

20. The computer implemented method of claim 19, wherein updating the workspace further comprises:
searching files stored on the messaging system using the text string; and
displaying a third set of one or more file identifiers corresponding to files stored on the messaging system on the workspace.
